(19) United States
(12) Patent Application Publication
(10) Pub. No.: US 2025/0085722 A1
(43) Pub. Date: Mar. 13, 2025

(54) MATERIAL SUPPLY SYSTEM AND MATERIAL SUPPLY METHOD

(71) Applicant: Kubota Corporation, Osaka (JP)

(72) Inventor: Kenji TAMATANI, Sakai-shi (JP)

(21) Appl. No.: 18/958,681

(22) Filed: Nov. 25, 2024

Related U.S. Application Data
(63) Continuation of application No. PCT/JP2023/019919, filed on May 29, 2023.

(30) Foreign Application Priority Data
May 30, 2022 (JP) 2022-087422

(51) Int. Cl. G05D 1/667; A01B 76/00; A01C 11/02; G05D 105/15; G05D 107/20; G06Q 10/1093; G06Q 50/02

(52) U.S. Cl. CPC G05D 1/667; A01B 76/00; A01C 11/02; G05D 2105/15; G05D 2107/21; G06Q 10/1097; G06Q 50/02

(57) ABSTRACT

A material supply system that causes a transport vehicle to supply an agricultural material for consumption by an agricultural machine in agricultural work includes a computer configured or programmed to determine a transport start timing for the transport vehicle toward a delivery location of the agricultural material, based on a consumption status of the agricultural material in an agricultural task by the agricultural machine in a field, a position of a storage location of the agricultural material, and a position of the delivery location of the agricultural material.

### CROSS REFERENCE TO RELATED APPLICATIONS

This application claims the benefit of priority to Japanese Patent Application No. 2022-087422 filed on May 30, 2022 and is a Continuation Application of PCT Application No. PCT/JP2023/019919 filed on May 29, 2023. The entire contents of each application are hereby incorporated herein by reference.

### BACKGROUND OF THE INVENTION

### 1. Field of the Invention

The present disclosure relates to material supply systems and material supply methods.

### 2. Description of the Related Art

As attempts in next-generation agriculture, research and development of smart agriculture utilizing ICT (Information and Communication Technology) and IoT (Internet of Things) are under way. Research and development are also directed to the automation and unmanned use of tractors, rice transplanters, combines, and other agricultural machines to be used in the field. For example, work vehicles that perform agricultural work while automatically traveling in the field by utilizing a positioning system that is capable of precise positioning, e.g., a GNSS (Global Navigation Satellite System), are coming into practical use.

Some agricultural machines are work vehicles that perform agricultural work while consuming agricultural materials such as seedlings, seeds, fertilizers, or chemical agents (which hereinafter may simply be referred to as “materials”). Such work vehicles include, for example, rice transplanters, vegetable transplanters, and tractors having an implement (e.g., a seeder, a spreader, a chemical sprayer, or the like) attached thereto. If a material runs short in the middle of a task being performed by the work vehicle, it becomes necessary to replenish the material.

Japanese Laid-Open Patent Publication No. 2018-39 discloses an example of a method of performing efficient replenishment of a material for a work vehicle. In the method disclosed in Japanese Laid-Open Patent Publication No. 2018-39, a work vehicle detects a remaining amount of a material carried on itself (e.g., seedlings, seeds, fertilizer, chemical agent, fuel, etc.), and when there is little remaining material, a driver and an assistant worker who makes preparations to replenish the material are alerted. Receiving the alert, after finishing travel along a line of tasked travel within the field, the driver stops the work vehicle near a furrow at which material replenishment is to be performed. On the other hand, receiving the alert, the assistant worker begins preparations for material replenishment. As a result, the material can be replenished, from the furrow to the work vehicle, with ease.

### SUMMARY OF THE INVENTION

In a conventional method of material replenishment for a work vehicle, it is necessary to prepare a sufficient amount of material at a predetermined replenishment position in advance. For example, from a material storage, a sufficient amount of material needs to be transported in advance by using a transport vehicle, and the material needs to be placed at a furrow around the field or at a replenishment position on an agricultural road. However, with such a method, the material may be left at the replenishment position for long periods of time, thus obstructing passage or allowing direct sunlight to dry the material (e.g., seedlings) to result in a degraded quality.

Example embodiments of the present invention provide systems and methods for solving the aforementioned problems.

A material supply system according to an example embodiment of the present disclosure is a system that causes a transport vehicle to supply an agricultural material for consumption by an agricultural machine in agricultural work. The system includes a computer configured or programmed to determine a transport start timing for the transport vehicle toward a delivery location of the agricultural material, based on a consumption status of the agricultural material in an agricultural task by the agricultural machine in a field, a position of a storage location of the agricultural material, and a position of the delivery location.

A material supply method according to another example embodiment of the present disclosure is a method of causing a transport vehicle to supply an agricultural material for consumption by an agricultural machine in agricultural work. The method includes acquiring information of a consumption status of the agricultural material in an agricultural task by the agricultural machine in a field, information of a position of a storage location of the agricultural material, and information of a position of a delivery location of the agricultural material, based on the consumption status of the agricultural material, the position of the storage location, and the position of the delivery location, determining a transport start timing for the transport vehicle toward the delivery location, and providing information indicating the transport start timing for a controller configured or programmed to control self-driving of the transport vehicle.

Technologies and example embodiments of the present disclosure may be implemented using devices, systems, methods, integrated circuits, computer programs, non-transitory computer-readable storage media, or any combination thereof. The computer-readable storage media may be inclusive of volatile storage media, or non-volatile storage media. The devices may include a plurality of devices. In the case where the devices include two or more devices, the two or more devices may be provided within a single apparatus, or divided over two or more separate apparatuses.

According to example embodiments of the present disclosure, it is possible to efficiently supply agricultural material to agricultural machines.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a block diagram showing an example configuration of a material supply system according to an illustrative example embodiment of the present disclosure.

FIG. 2 is a flowchart showing an example of an operation by a computer.

FIG. 3 is a flowchart showing an example of more detailed operation of acquiring information on a consumption status of an agricultural material.

FIG. 4 is a flowchart showing an example of more detailed operation of a step of determining a transport start timing of a transport vehicle.

FIG. 5 is a flowchart showing another example of an operation by the computer.

FIG. 6A is a diagram illustrating an example of an agricultural machine performing agricultural work within a field and a transport vehicle standing by at a storage location of a material.

FIG. 6B is a diagram schematically showing the transport vehicle having arrived at a delivery location.

FIG. 6C is a diagram schematically showing a material being delivered from the transport vehicle to the agricultural machine.

FIG. 6D is a diagram schematically showing a situation where the transport vehicle is on its way of returning to a storage location.

FIG. 7 is a diagram showing an example where the transport vehicle circulates through a route that includes a storage location and a delivery location.

FIG. 8 is a block diagram showing an example configuration for the material supply system.

FIG. 9 is a block diagram showing another example configuration for the material provision system.

FIG. 10 is a block diagram showing still another example configuration for the material provision system.

FIG. 11A is a diagram showing an example of an overall operation of the material supply system.

FIG. 11B shows a diagram showing an example of an overall operation of another example of the material supply system.

FIG. 11C is a diagram showing an example of an overall operation of still another example of the material supply system.

FIG. 12 is a diagram showing an example of a work plan for the agricultural machine.

FIG. 13 is a side view showing an example configuration for a rice transplanter,

### DETAILED DESCRIPTION OF THE EXAMPLE EMBODIMENTS

In the present disclosure, an “agricultural machine” refers to a machine for agricultural applications. Examples of agricultural machines include tractors, rice transplanters, vegetable transplanters, seeders, spreaders, chemical sprayers, harvesters, combines, vehicles for crop management, mowers, and mobile robots for agriculture. Not only may a work vehicle such as a tractor function as an “agricultural machine” alone by itself, but also a combination of a work vehicle and an implement that is attached to, or towed by, the work vehicle may function as an “agricultural machine”. For the ground surface inside a field, the agricultural machine performs agricultural work such as planting of crops, seeding, pest control, manure spreading, tilling, planting of crops, or harvesting. Such agricultural work or tasks may be referred to as “groundwork”, or simply as “work” or “tasks”. Travel of a vehicle-type agricultural machine performed while the agricultural machine also performs agricultural work may be referred to as “tasked travel”. An agricultural machine may have self-driving functionality, or travel via manual driving.

An “agricultural material” means supply to be consumed by agricultural work that is performed by an agricultural machine. Examples of agricultural materials may include crop seedlings, seeds, fertilizers, and chemical agents such as herbicides or insecticides. An agricultural material is carried on an agricultural machine, and is consumed as the agricultural machine performs agricultural work such as planting of a crop, seeding, manure spreading, or chemical spraying.

A “transport vehicle” is a vehicle that is used to transport an agricultural material. Transport vehicles are vehicles that can travel along roads, e.g., trucks (lorries), vans, tractors, passenger autos, or motorcycles, for example. From a previously-determined storage location of an agricultural material, a transport vehicle transports the agricultural material to a delivery location where the agricultural material is supposed to be delivered to an agricultural machine. A transport vehicle may have self-driving functionality, or travel via manual driving.

“Self-driving” refers to controlling the movement of an agricultural machine or a movable unit such as a transport vehicle by the action of a controller, rather than through manual operations of a driver. An agricultural machine that performs self-driving may be referred to as a “self-driving agricultural machine” or a “robotic agricultural machine”. During self-driving of an agricultural machine, not only the movement of the agricultural machine, but also the operation of agricultural work (e.g., the operation of the implement) may be controlled automatically. When a vehicle-type agricultural machine or transport vehicle travels via self-driving, it is referred to as “self-traveling”. The controller may be configured or programmed to control at least one of steering that is required in the movement of the vehicle, adjustment of the moving speed, and beginning and ending of a move. In the case of controlling a work vehicle having an implement attached thereto, the controller may be configured or programmed to control raising or lowering of the implement, beginning and ending of an operation of the implement, and so on. A move based on self-driving may include not only moving of a movable unit that goes along a predetermined path toward a destination, but also moving of a movable unit that follows a target of tracking. A movable unit that performs self-driving may also move partly based on the user's instructions. Moreover, a movable unit that performs self-driving may operate not only in a self-driving mode but also in a manual driving mode, where the movable unit moves through manual operations of the driver. When performed not manually but through the action of a controller, the steering of a movable unit will be referred to as “automatic steering”. A portion of, or the entirety of, the controller may reside outside the movable unit. Control signals, commands, data, etc., may be communicated between the movable unit and a controller residing outside the movable unit. A movable unit that performs self-driving may move autonomously while sensing the surrounding environment, without any person being involved in the controlling of the movement of the movable unit. A movable unit that is capable of autonomous movement is able to travel inside the field or outside the field (e.g., on roads) in an unmanned manner. During an autonomous move, operations of detecting and avoiding obstacles may be performed.

Hereinafter, example embodiments of the present disclosure will be described more specifically. Note however that unnecessarily detailed descriptions may be omitted. For example, detailed descriptions on what is well known in the art or redundant descriptions on what is substantially the same configuration may be omitted. This is to avoid lengthy description, and facilitate the understanding of those skilled in the art. The accompanying drawings and the following description, which are provided by the present inventors so that those skilled in the art can sufficiently understand the present disclosure, are not intended to limit the scope of claims. In the following description, component elements having identical or similar functions are denoted by identical reference numerals.

The following example embodiments are only exemplary, and the techniques according to the present disclosure is not limited to the following example embodiments. For example, numerical values, shapes, materials, steps, and orders of steps, layout of a display screen, etc., that are indicated in the following example embodiments are only exemplary, and allow for various modifications so long as it makes technological sense. Any one implementation may be combined with another so long as it makes technological sense to do so.

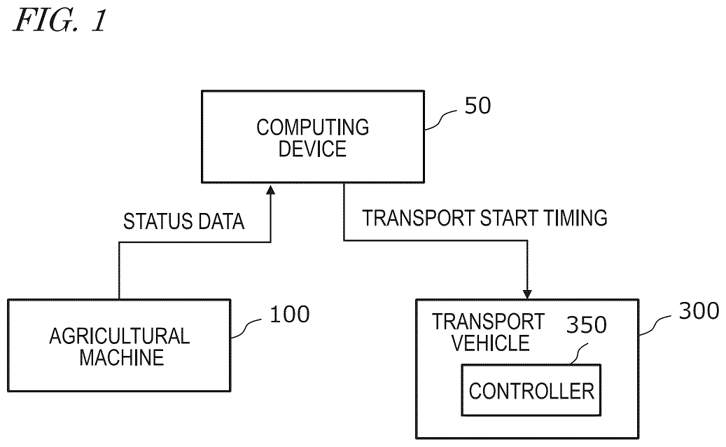

FIG. 1 is a block diagram showing an example configuration of a material supply system according to an illustrative example embodiment of the present disclosure. The material supply system is a system that causes a transport vehicle 300 to supply an agricultural material for consumption by an agricultural machine 100 in agricultural work. The material supply system shown in FIG. 1 includes a computer 50, an agricultural machine 100, and a transport vehicle 300. In the example of FIG. 1, the agricultural machine 100 and the transport vehicle 300 are included in the material supply system. However, the agricultural machine 100 and the transport vehicle 300 may be external elements to the material supply system.

The agricultural machine 100 may be a work vehicle that performs tasked travel while consuming an agricultural material within a field. For example, the agricultural machine 100 may be a transplanter that travels while planting seedlings of a plant in the field, e.g., a riding rice transplanter or a vegetable transplanter. In that case, agricultural materials including seedlings of the plant are to be carried on the agricultural machine 100. In addition to seedlings of the plant, other materials such as a fertilizer may also be carried on the agricultural machine 100. Without being limited to a transplanter, the agricultural machine 100 may be a work vehicle that performs other kinds of agricultural work, such as seeding, manure spreading, or pest control. For example, the agricultural machine 100 may be a tractor or a vehicle for crop management, having attached thereto an implement that is configured to perform agricultural work such as seeding, manure spreading, or pest control. While consuming an agricultural material such as crop seedlings, seeds, fertilizers, herbicides, or insecticides, for example, the agricultural machine 100 performs tasked travel within the field. The agricultural machine 100 has a function of communicating with the computer 50. The agricultural machine 100 may be configured or programmed to, while performing tasked travel, transmit data representing the consumption status (consumed amount, remaining amount, etc.) of a material, or data to be referred to for estimating the consumption status of a material (e.g., the position or traveling speed of the agricultural machine 100) to the computer 50, for example. In the present specification, such data may be referred to as “status data”. The agricultural machine 100 travels via self-driving or manual driving.

The transport vehicle 300 is a vehicle that transports materials such as crop seedlings, fertilizers, or agrochemicals. The transport vehicle 300 may be a vehicle that is suitable for material transportation, e.g., a truck (lorry) or a van, for example. The transport vehicle 300 has the function of communicating with the computer 50, and self-driving functionality. In the example of FIG. 1, the transport vehicle 300 includes a controller 350 to control self-driving travel. The controller 350 may be implemented by an electronic control unit (ECU) that is provided in the transport vehicle 300, for example. Although the transport vehicle 300 may include a positioning device including a GNSS receiver, a camera(s), and/or LiDAR (Light Detection and Ranging) or other sensors, such component elements are omitted from illustration in FIG. 1.

The controller 350 may be provided on or in a device that is external to the transport vehicle 300. For example, a computer, e.g., a server, that is configured or programmed to communicate with the transport vehicle 300 may have the functionality of the controller 350. In that case, the transport vehicle 300 travels in accordance with a command from the external controller. Through the action of the controller 350, the transport vehicle 300 transports a material, from a storage location of the material to a delivery location of the material, via self-driving.

A storage location of a material is a previously determined place, such as a material storage, for example. A delivery location of a material is a predetermined place such as an agricultural road or a furrow around the field, for example. The delivery location may be a fixed place that is set for each field, or may be a place that is set in accordance with work situation of the agricultural machine 100. Based on information indicating a transport start timing that is acquired from the computer 50, the transport vehicle 300 automatically begins transportation of the material.

The computer 50 may be a circuit or a computer that includes one or more processors such as a CPU (Central Processing Unit), a GPU (Graphics) Processing Unit), or an FPGA (Field Programmable Gate Array), and one or more storage media such as a memory(s), for example. The computer 50 may be provided in a computer, e.g., a server, that is provided at a remote place from the agricultural machine 100 and the transport vehicle 300. Alternatively, the computer 50 may be provided in the agricultural machine 100 or the transport vehicle 300, For example, an ECU provided in the agricultural machine 100 or the transport vehicle 300 may function as the computer 50. Thus, the computer 50 may be mounted in or on the agricultural machine 100, the transport vehicle 300, or a computer that communicates with the agricultural machine 100 and the transport vehicle 300.

The computer 50 is configured or programmed to determine a transport start timing at which the transport vehicle 300 is to begin transportation of the agricultural material. For example, the computer 50 is configured or programmed to determine the transport start timing for the transport vehicle toward the delivery location, based on the consumption status of the agricultural material in an agricultural task by the agricultural machine 100 in the field, the position of a storage location of the agricultural material, and the position of a delivery location of the agricultural material. The computer 50 is configured or programmed to send information indicating information indicating the determined transport start timing to the transport vehicle 300. At the transport start timing, the transport vehicle 300 begins self-traveling from the storage location to the delivery location of the material.

The consumption status of the agricultural material may be determined or estimated based on status data that is received from the agricultural machine 100. The status data may be, for example, data representing a remaining amount of the material carried on the agricultural machine 100 or a position or a moving speed of the agricultural machine 100. Based on the status data, the computer 50 can determine the remaining amount of the material carried on the agricultural machine 100, and estimate how much more distance or time the tasked travel is still possible. Based on the estimated distance or time, the computer 50 can estimate at least one of a timing (time of depletion) at which the material becomes depleted, and a position (point of depletion) of the agricultural machine 100 at which the material becomes depleted. As used herein, when the “material becomes depleted”, it is meant that remaining amount of the material becomes equal to or less than a predetermined threshold (e.g., a value close to 0).

The position of the storage location and the position of the delivery location are previously set, and the positional information thereof may be recorded in a storage that is internal or external to the computer 50. The position of the delivery location may not be at a fixed position, and may be determined in accordance with the state of the agricultural machine 100. For example, the computer 50 may set a delivery location near a point of depletion at which the material carried on the agricultural machine 100 is estimated to become depleted. In that case, in addition to information indicating the transport start timing, the computer 50 may transmit positional information of the delivery location to the transport vehicle 300.

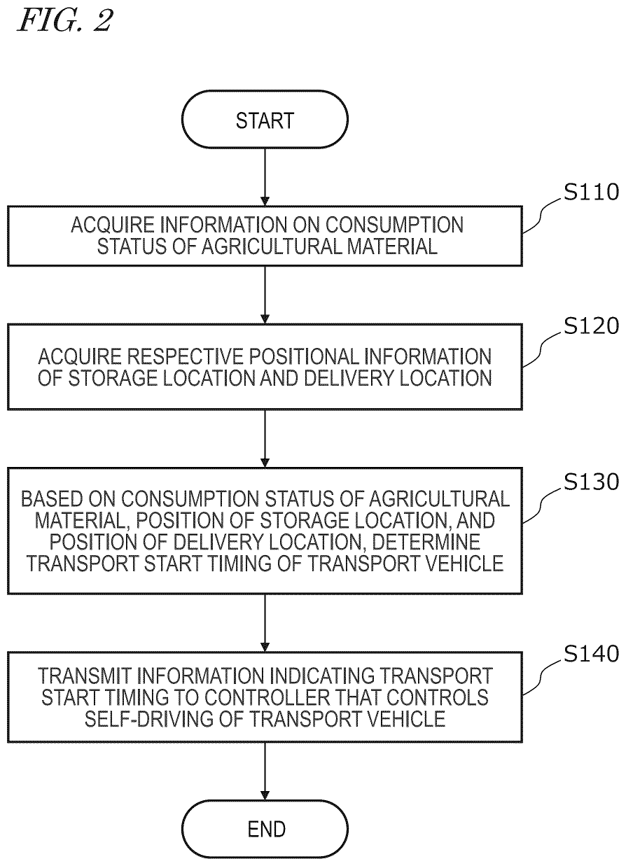

FIG. 2 is a flowchart showing an example of an operation by the computer 50. The computer 50 in this example may be configured or programmed to perform the operations from steps S110 to S140 shown in FIG. 2. Hereinafter, the operation of each step will be described.

At step S110, the computer 50 is configured or programmed to acquire information on the consumption status of the agricultural material, Information on the consumption status of the agricultural material may be information indicating the consumed amount or remaining amount of the material, for example. The computer 50 is configured or programmed to monitor the state of the agricultural machine 100, and based on the state of the agricultural machine 100, determines or estimates the consumption status of the agricultural material. The state of the agricultural machine 100 to be monitored may be the remaining amount of the material carried on the agricultural machine 100, the position of the agricultural machine 100, the traveling speed of the agricultural machine 100, or the like, for example. Based on status data that is consecutively transmitted from the agricultural machine 100 while the agricultural machine 100 is performing tasked travel, the computer 50 determines the consumption status of the agricultural material. The status data may include data representing a remaining amount of the material as measured by a sensor that is mounted on the agricultural machine 100, for example. In that case, the computer 50 can immediately determine the consumption status of the material from the data representing the remaining amount of the material transmitted from the agricultural machine 100. Alternatively, the status data may include information of the position of the agricultural machine 100 as measured by a positioning device included in the agricultural machine 100. Furthermore, the status data may include information of the moving speed of the agricultural machine 100. Based on the information of the position or moving speed of the agricultural machine 100 consecutively acquired from the agricultural machine 100, the computer 50 can estimate the consumed amount or remaining amount of the material.

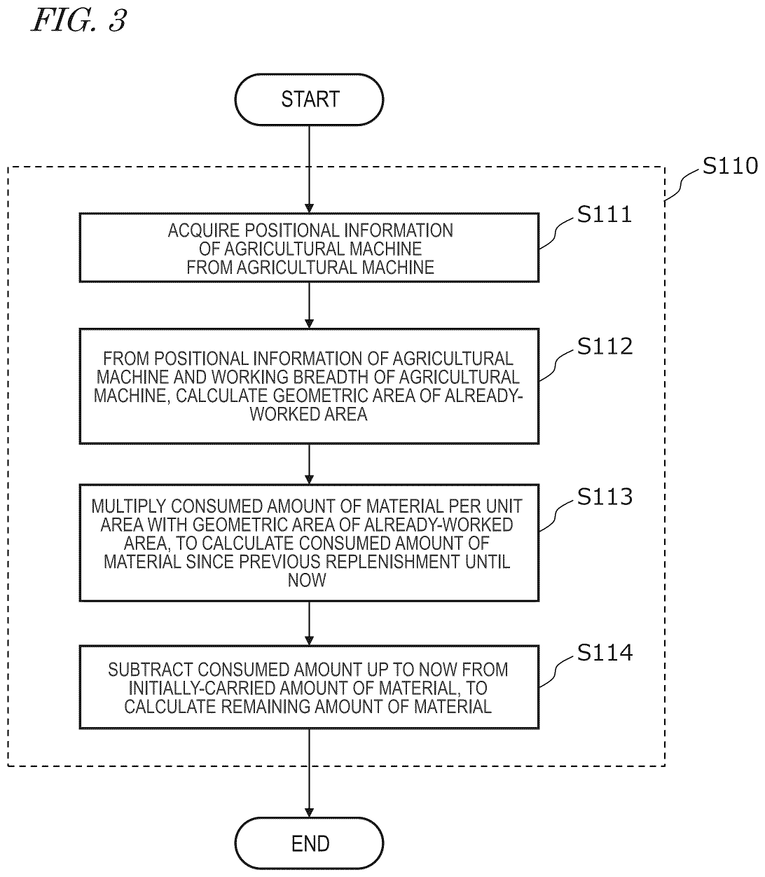

FIG. 3 is a flowchart showing an example of more detailed operation of step S110. In the example shown in FIG. 3, the Computer 50 is configured or programmed to monitor the position of the agricultural machine 100, and based on the position of the agricultural machine 100, estimate the consumption status of the agricultural material. In the example of FIG. 3, step S110 includes steps S111 to S114.

At step S111, the computer 50 is configured or programmed to acquire chronological data of the position of the agricultural machine 100 from the agricultural machine 100. With a fixed cycle, for example, the agricultural machine 100 transmits information indicating the position of the agricultural machine 100 as measured by a positioning device, e.g., a GNSS receiver, to the computer 50. As a result, the computer 50 is able to acquire chronological data of the position of the agricultural machine 100.

At step S112, from the chronological data of the position of the agricultural machine 100 and the working breadth of the agricultural machine 100, the computer 50 is configured or programmed to calculate the geometric area of an already-worked area for which the work has been completed. Specifically, from the chronological data of position, the computer 50 is configured or programmed to determine a distance that has been traveled by the agricultural machine 100 while performing a task that involves consumption of the material since the last time the material was replenished and until now, and by multiplying the distance with the working breadth, calculates a geometric area of the already-worked area. Herein, the working breadth of the agricultural machine 100 is known, and the information thereof is recorded in the storage in advance.

At step S113, the computer 50 is configured or programmed to calculate a consumed amount of the material by multiplying the consumed amount of the material per unit area with the geometric area of the already-worked area. The consumed amount of the material per unit area is known, and the information thereof is recorded in the storage in advance.

At step S114, the computer 50 is configured or programmed to calculate a remaining amount of the material by subtracting the consumed amount up to now from an initially-carried amount of the material. The initially-carried amount of the material is known, and the information thereof is recorded in the storage in advance.

With the above method, the computer 50 can acquire information of the remaining amount of the material, as information indicating the consumption status of the material. Note that the operation shown in FIG. 3 is an example, and the consumption status of the material may be estimated by other methods. For example, in a case where the agricultural machine 100 is a self-driving agricultural machine and performs self-traveling along a target path that is set within the field, the geometric area of the already-worked area can be determined based on information of the target path and on the current position of the agricultural machine 100.

At step S120 shown in FIG. 2, the computer 50 is configured or programmed to acquire respective positional information of the storage location and the delivery location. The positions of the storage location and the delivery location are known, and the positional information thereof is recorded in the storage in advance. Note that the position of the delivery location may be changed in accordance with the position of the agricultural machine 100. For example, based on the consumption status of the agricultural material, the work path of the agricultural machine 100, and the position and moving speed of the agricultural machine 100, the computer 50 may estimate a point of depletion at which the remaining amount of the agricultural material becomes smaller than a predetermined amount, and determine a delivery location in accordance with the point of depletion. Through such operation, a place near the point of depletion can be set as a delivery location, such that the movement of the agricultural machine 100 for material replenishment can be reduced. Step S120 may be performed before step S110, or Concurrently with step S110.

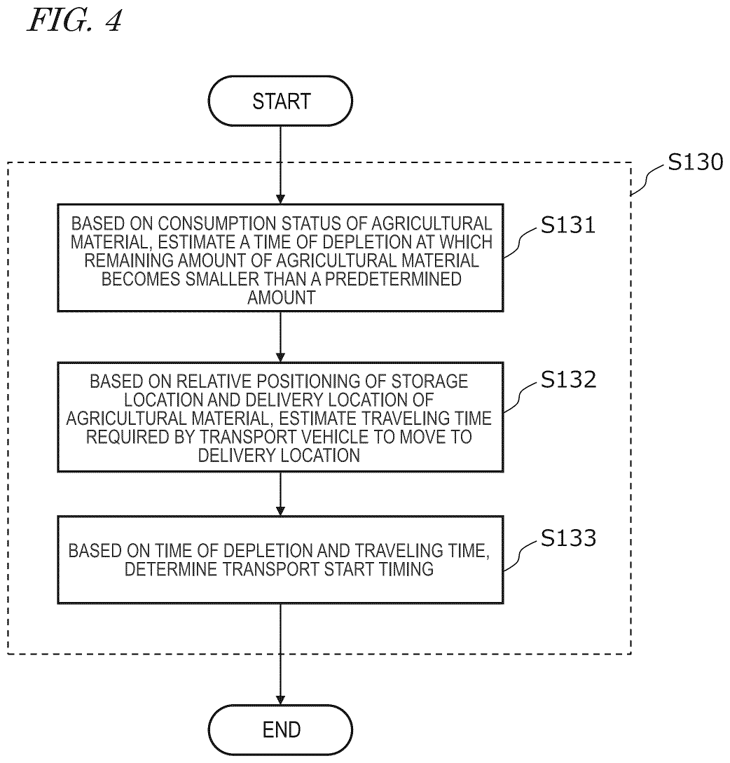

At step S130, based on the consumption status of the agricultural material, the position of the storage location, and the position of the delivery location, the computer 50 determines a transport start timing of the transport vehicle 300 toward the delivery location. For example, the computer 50 may determine the transport start timing by performing a process shown in FIG. 4.

FIG. 4 is a flowchart showing a specific example of the operation of step S130, In the example of FIG. 4, step S130 includes steps S131 to S133.

At step S131, based on the consumption status of the agricultural material, the computer 50 is configured or programmed to estimate a time of depletion at which the remaining amount of the agricultural material becomes smaller than a predetermined amount. For example, first, based on the moving speed of the agricultural machine 100, the working breadth of the agricultural machine 100, and the consumed amount of the material per unit area, the computer 50 is configured or programmed to calculate a consumed amount of the material per unit time. Next, by dividing the current remaining amount of the material with the consumed amount of the material per unit time, the computer 50 is configured or programmed to calculate an amount of time left until the material will become depleted, thus estimating a time of depletion.

At step S132, based on a relative positioning of the storage location of the agricultural material and the delivery location of the agricultural material, the Computer 50 is configured or programmed to estimate a traveling time required by the transport vehicle 300 in order to move to the delivery location. For example, the computer 50 is configured or programmed to first read an environment map including information on roads around the field from the storage, and based on the environment map, determine a path from the storage location to the delivery location. Next, the computer 50 is configured or programmed to calculate an amount of time required by the transport vehicle 300 in order to travel from the storage location to the delivery location along the path. For example, assuming that the transport vehicle 300 travels at a certain average speed, the computer 50 may divide the overall length of the path by the average speed to calculate the traveling time of the transport vehicle 300. Note that step S132 may be performed before step S131, or simultaneously with the step S131.

At step S133, based on the estimated time of depletion and traveling time, the computer 50 is configured or programmed to determine a transport start timing. More specifically, as the transport start timing, the computer 50 is configured or programmed to determine a timing before a point in time that is derived by subtracting the traveling time from the time of depletion. For example, the computer 50 may determine as the transport start timing a point in time that is derived by subtracting from the time of depletion an amount of time that results by multiplying the traveling time with a coefficient of one or greater. Alternatively, the computer 50 may determine as the transport start timing a point in time which is a predetermined amount of time earlier than a point in time that is derived by subtracting the traveling time from the time of depletion.

After step S133, the process proceeds to step S140 shown in FIG. 2. At step S140, the computer 50 is configured or programmed to transmit information indicating the transport start timing to the controller 350, which is configured or programmed to control self-driving of the transport vehicle 300. For example, the computer 50 may transmit to the controller 350 of the transport vehicle 300 a traveling command including information of the transport start timing. Upon acquiring information indicating the transport start timing, the controller 350 is configured or programmed to initiate self-traveling from the storage location to the delivery location at the transport start timing. As a result, while carrying the material, the transport vehicle 300 begins self-traveling from the storage location to the delivery location.

In the above operation, the amount of time after the transport vehicle 300 leaves the storage location and until the material carried on the agricultural machine 100 becomes depleted is longer than the traveling time for the transport vehicle 300 to reach the delivery location after leaving the storage location. Therefore, the transport vehicle 300 is able to arrive at the delivery location before the material carried on the agricultural machine 100 becomes depleted. Once the transport vehicle 300 arrives at the delivery location, the agricultural machine 100 stops the work and heads for the delivery location. At the delivery location, the material is delivered from the transport vehicle 300 to the agricultural machine 100. According to the present example embodiment, there is no need to prepare large amounts of material at the delivery location in advance, and an amount of material that is needed by the agricultural machine 100 can be transported to the transport vehicle 300 at an appropriate timing. Therefore, the problems associated with the material being left at the delivery location (i.e., the replenishment point) for long periods of time to obstruct passage, or the quality of the material being degraded by direct sunlight, can be solved.

Note that the operation shown in FIG. 2 is only an example, and a different operation from the operation shown in FIG. 2 may be performed. For example, after determining the transport start timing at step S130, the computer 50 may determine a loading start timing at which to begin loading of the agricultural material onto the transport vehicle 300. The computer 50 may transmit information indicating the determined loading start timing to a terminal that is used by a worker to perform the work of loading the material onto the transport vehicle 300. Hereinafter, an example of such an operation will be described.

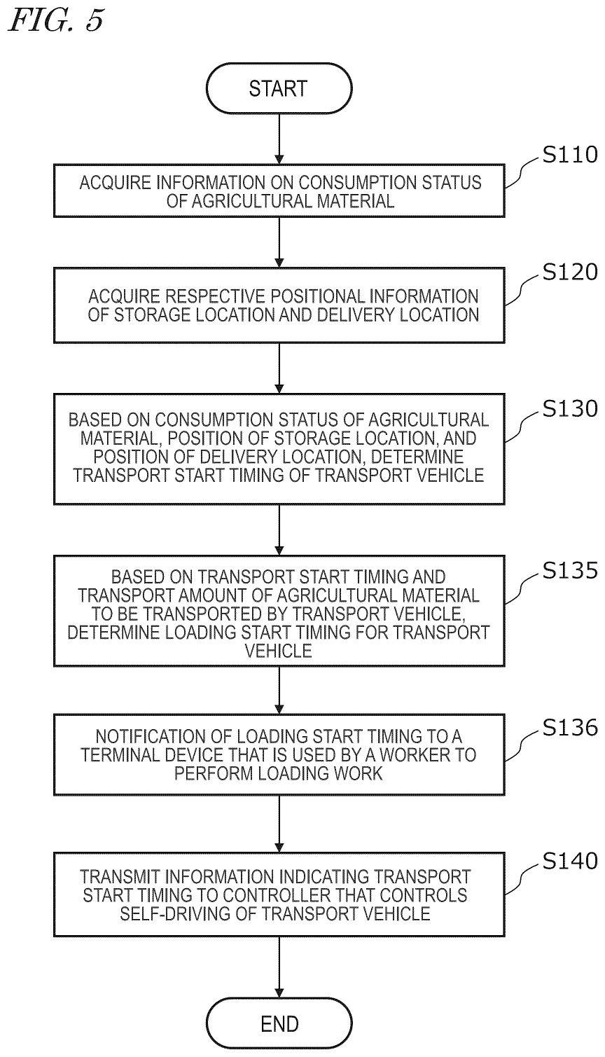

FIG. 5 is a flowchart showing a variation of the operation shown in FIG. 2. In the flowchart shown in FIG. 5, steps S135 and S136 are added between step S130 and step S140. Otherwise, it is identical to the operation shown in FIG. 2.

At step 8135, the computer 50 is configured or programmed to determine a loading start timing for the transport vehicle 300 based on the transport start timing and a transport amount of the agricultural material to be transported by the transport vehicle 300. The transport amount of agricultural material to be transported by the transport vehicle 300 is previously set, and is recorded in the storage. Based on this transport amount, the computer 50 is configured or programmed to estimate a loading time required for loading the agricultural material onto the transport vehicle 300, and determine, as the loading start timing, a timing before a point in time that is derived by subtracting the loading time from the transport start timing. For example, the computer 50 may determine, as the loading start timing, a point in time that is derived by subtracting from the transport start timing an amount of time that results by multiplying the loading time with a coefficient of one or greater. Alternatively, the computer 50 may determine, as the loading start timing, a point in time which is a predetermined amount of time earlier than a point in time that is derived by subtracting the loading time from the transport start timing.

At step S136, the computer 50 is configured or programmed to provide a notification of the loading start timing to a terminal that is used by a worker to perform the loading work. This allows the worker to know that loading of the material onto the transport vehicle 300 may be begun at the notified loading start timing. At step S136, in addition the loading start timing, the computer 50 may also give a notification of the transport start timing to the terminal. This allows the worker to know that the loading work needs to be completed by the transport start timing.

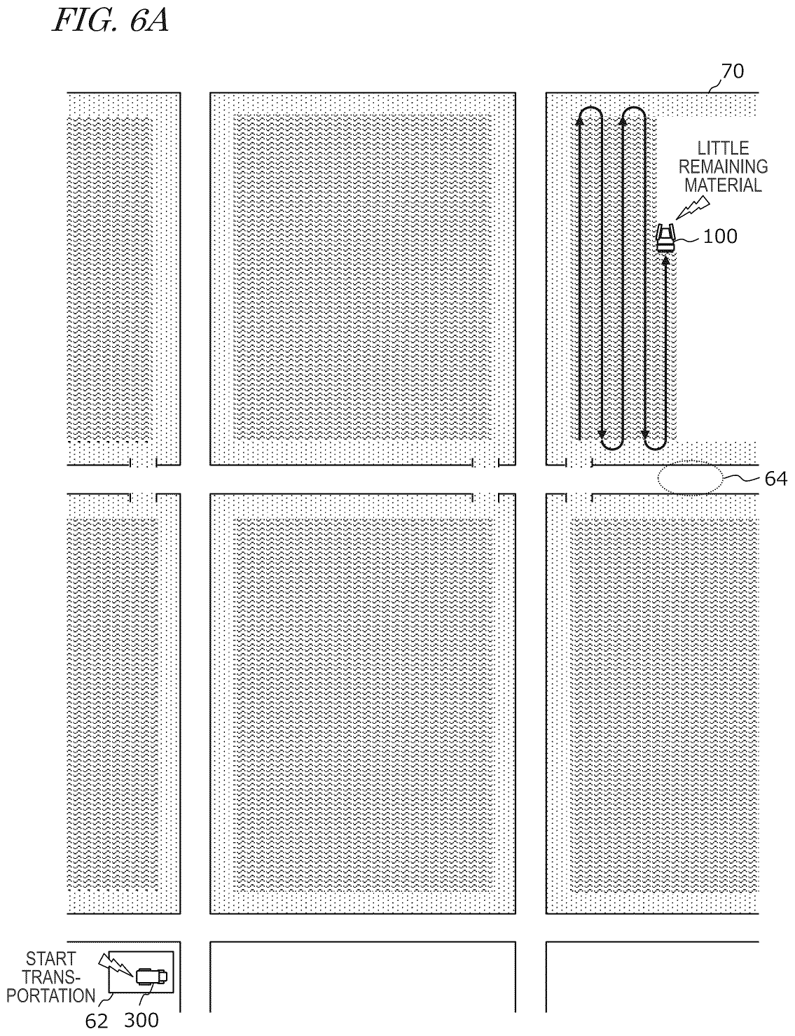

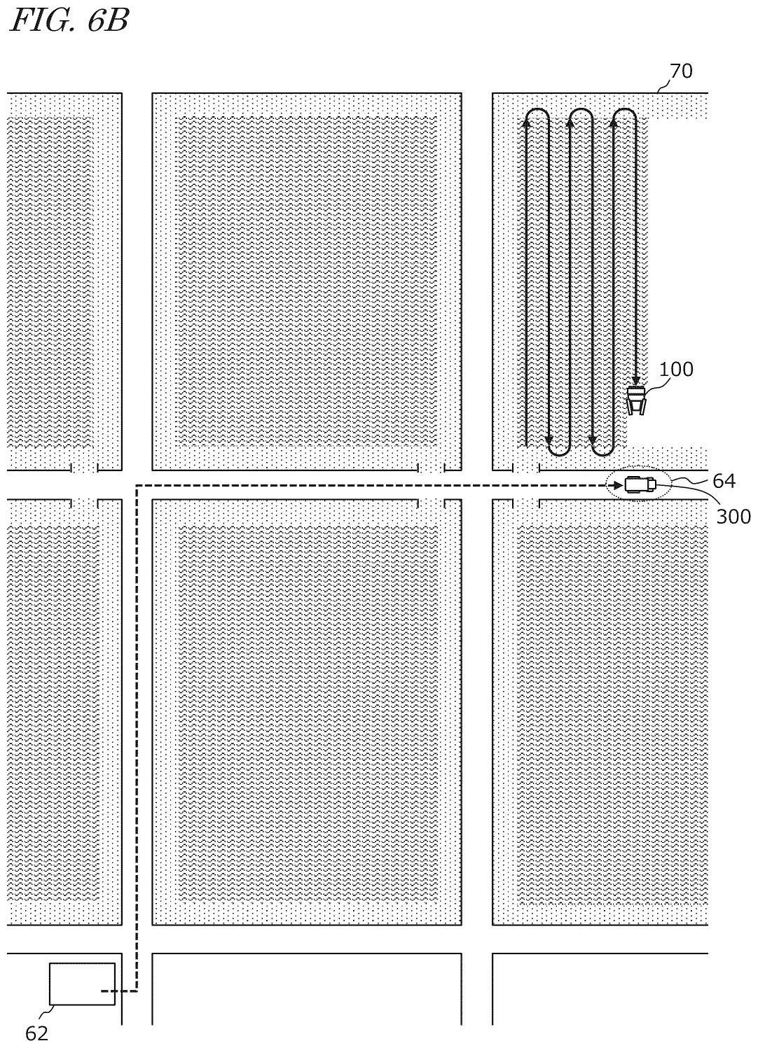

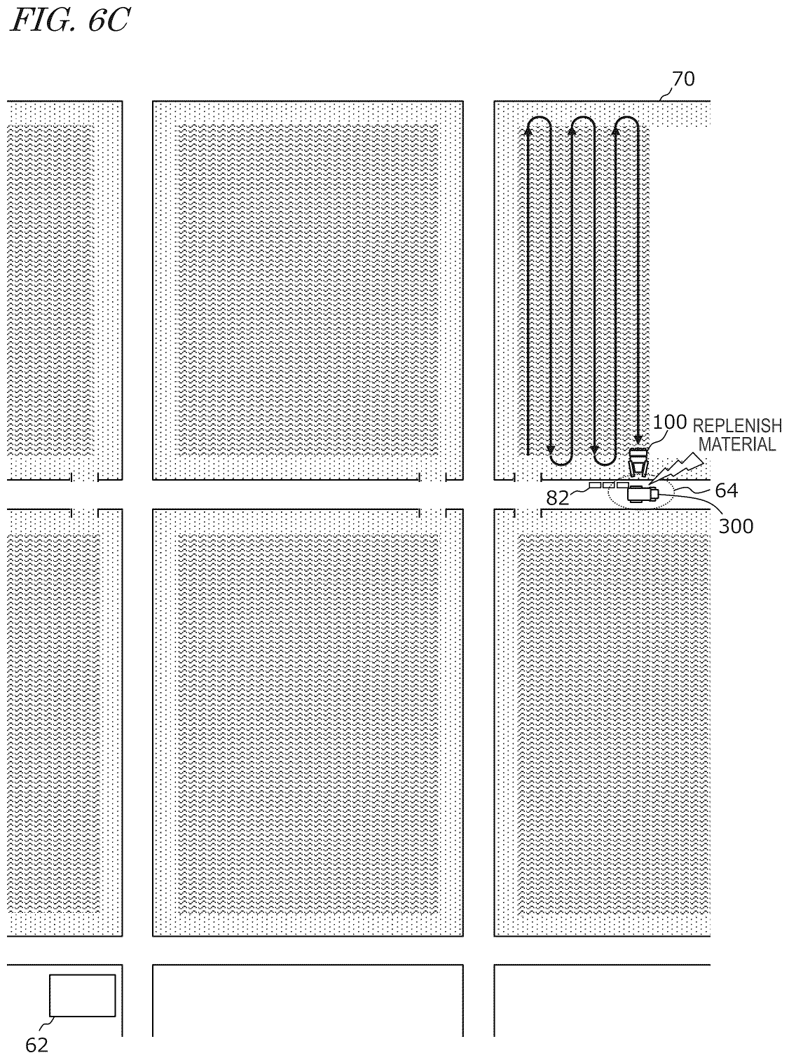

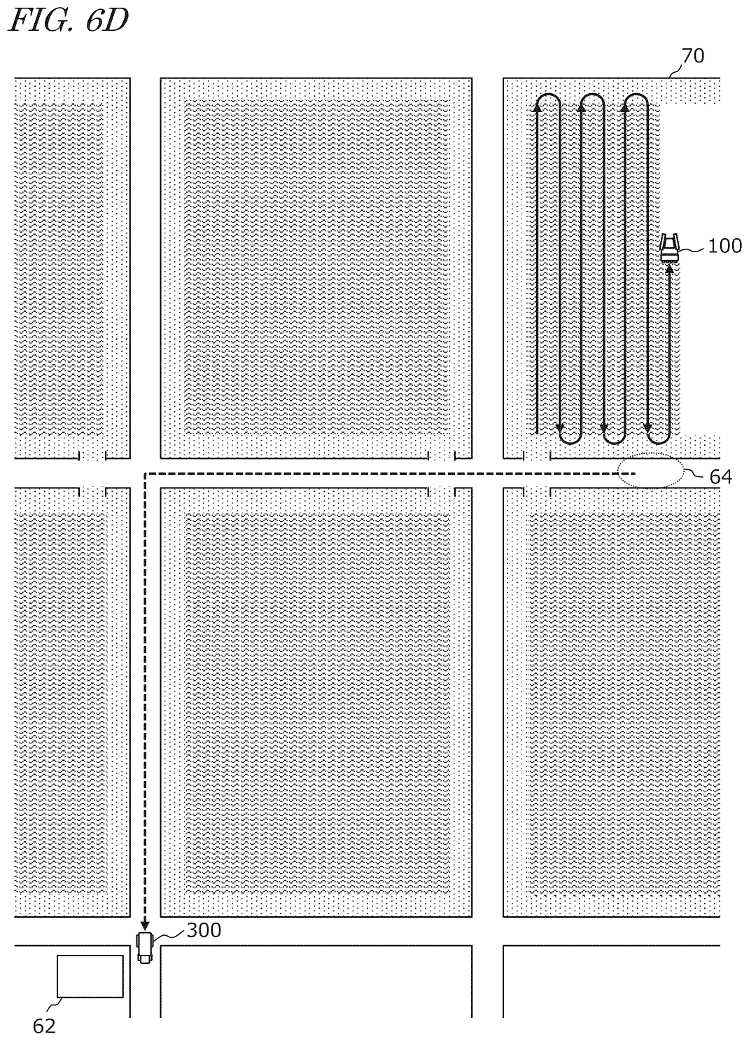

Next, with reference to FIGS. 6A to 6D, a more specific example of the operation by the material supply system will be described.

FIG. 6A is a diagram illustrating an example of the agricultural machine 100 performing agricultural work within a field 70 and a transport vehicle 300 standing by at a storage location 62 of the material. The field 70 in this example is a paddy field, the agricultural machine 100 is a riding rice transplanter, the material is seedlings of a rice plant, and the transport vehicle 300 is a self-driving truck. The storage location 62 is a storage that is provided in order to store crop seedlings or other materials. A warehouse at a home or an office, etc., of the user of the agricultural machine 100 may be utilized as the storage location 62. Without being limited to existing in one place, storage locations 62 may exist in a plurality of places. The agricultural machine 100 performs rice planting work while traveling along a predetermined path within the field 70. Arrows in the field 70 in FIG. 6A illustrate a traveling locus of the agricultural machine 100. As shown in FIG. 6A, the agricultural machine 100 performs seedling planting work while repetitively reciprocating within the field 70.

While carrying a material (which in this example is seedlings of a rice plant), the transport vehicle 300 shown in FIG. 6A is standing by at the storage location 62 of the material. As described earlier, from the computer 50, information indicating the transport start timing of the material is sent to the controller 350 of the transport vehicle 300. When the remaining amount of the material carried on the agricultural machine 100 becomes small and it is the transport start timing, the transport vehicle 300 begins transporting the material to a delivery location 64 of the material. In this example, the delivery location 64 is set in an agricultural road around the field 70.

FIG. 6B is a diagram schematically showing the transport vehicle 300 having arrived at the delivery location 64. A broken arrow in FIG. 6B illustrates a traveling locus of the transport vehicle 300 along agricultural roads. As described earlier, the transport vehicle 300 arrives at the delivery location 64 before the material carried on the agricultural machine 100 becomes depleted.

FIG. 6C is a diagram schematically showing a material 82 being delivered from the transport vehicle 300 to the agricultural machine 100. At the delivery location 64, unloading of the material 82 from the transport vehicle 300 and replenishment of the material 82 for the agricultural machine 100 are performed. For example, this work may be performed by a worker such as a driver of the agricultural machine 100 or an assistant. When replenishment of the material 82 for the agricultural machine 100 is completed, the worker operates a device, such as control equipment of the transport vehicle 300 or a mobile terminal, to return the transport vehicle 300 to the storage location 62. In other words, after unloading of the agricultural material 82 from the transport vehicle 300 is completed at the delivery location 64, the controller 350 of the transport vehicle 300 initiates self-traveling from the delivery location 64 to the storage location 62, in response to a command from a device that is operated by a user (e.g., a worker). As a result, the transport vehicle 300 returns to the storage location 62 via self-driving.

FIG. 6D is a diagram schematically showing a situation where the transport vehicle 300 is on its way of returning to the storage location 62. After delivery of the material is completed, in response to a command from a device that is operated by the user, the transport vehicle 300 performs self-traveling toward the storage location 62. In the example of FIG. 6D, the transport vehicle 300 follows the same path as the path (forward path) shown in FIG. 6B to return to the storage location 62. The transport vehicle 300 may return to the storage location 62 via a different path from the forward path. For example, the controller 350 of the transport vehicle 300 may control the self-traveling of the transport vehicle 300 so as to circulate through a route that includes the storage location 62 and the delivery location 64, based on a previously-set operating schedule of the transport vehicle 300.

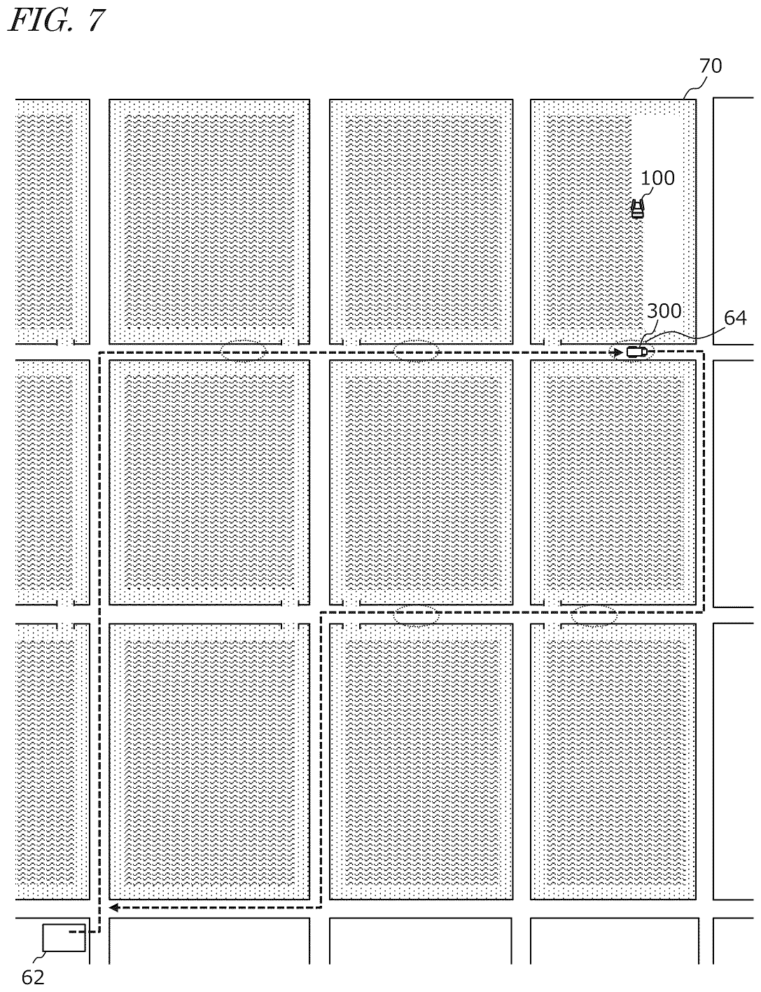

FIG. 7 is a diagram showing an example where the transport vehicle 300 circulates through a route that includes the storage location 62 and the delivery location 64. In FIG. 7, a number of dotted ellipses depict examples of delivery locations 64 for the material. In this example, a delivery location 64 is set for each of a plurality of fields 70 in which agricultural work is to be performed by the agricultural machine 100. The agricultural machine 100 in this example visits the plurality of fields 70 in order to perform agricultural work (e.g., rice planting). Because the amount of material that can be carried on the agricultural machine 100 in one time is limited, material replenishment becomes necessary while agricultural work is performed in each field 70. With the timing that the agricultural machine 100 needs material replenishment, the transport vehicle 300 transports the material to each delivery location 64. As shown by broken arrows in in FIG. 7, the transport vehicle 300 circulates through a route that includes the storage location 62 of the material and one or more delivery locations 64. In this example, the computer 50 is configured or programmed to instruct the transport vehicle 300 so that the transport vehicle 300 visits each delivery location 64 with the timing that material replenishment for the agricultural machine 100 becomes necessary in each field 70. As a result, material replenishment for the agricultural machine 100 can be achieved in a timely manner.

In the example of FIG. 7, one agricultural machine 100 successively performs agricultural work in the plurality of fields 70. Without being limited to this implementation, a plurality of agricultural machines may perform agricultural work in a field that it is assigned to, for example. In that case, the transport vehicle 300 is controlled so that, with the timing that material replenishment for the agricultural machine in each field becomes necessary, it transports the material to the delivery location for that field. A plurality of transport vehicles may be controlled to more efficiently perform transportation of the material to a plurality of delivery locations.

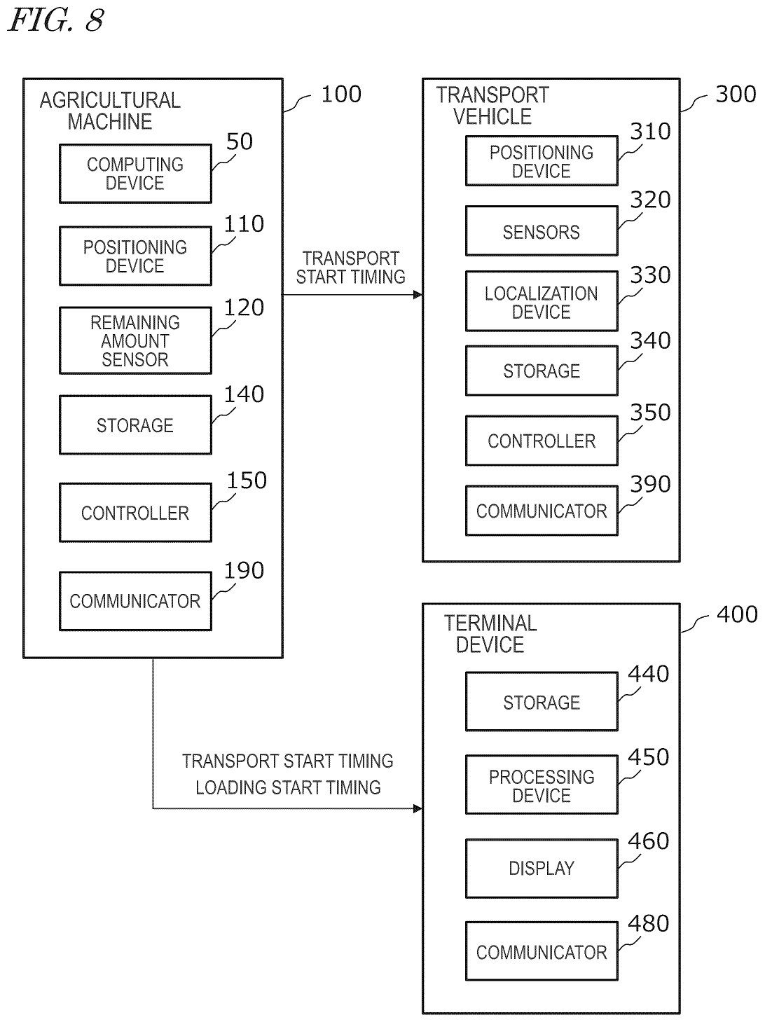

Next, with reference to FIG. 8 to FIG. 10, some variations for the configuration of the material supply system will be described,

FIG. 8 is a block diagram showing an example where the material supply system includes the agricultural machine 100, the transport vehicle 300, and a terminal 400. In this example, the computer 50 shown in FIG. 1 is mounted in or on the agricultural machine 100.

The agricultural machine 100 includes the computer 50, a positioning device 110, a remaining amount sensor 120, a storage 140, a controller 150, and a communicator 190. The positioning device 110 may include a GNSS receiver, for example. The GNSS receiver receives satellite signals that are transmitted from a plurality of GNSS satellites, and performs positioning based on the satellite signals. GNSS is a collective term for satellite positioning systems such as GPS (Global Positioning System), QZSS (Quasi-Zenith Satellite System), GLONASS, Galileo, and BeiDou. The positioning device 110 may include an inertial measurement unit (IMU). The IMU can measure a tilt or a small motion of the agricultural machine 100. The data acquired by the IMU can be used to complement the position data based on the satellite signals, so as to improve the performance of positioning. The remaining amount sensor 120 measures the remaining amount of the material carried on the agricultural machine 100. The remaining amount sensor 120 is a sensor to measure a physical parameter that varies with the remaining amount of the material, e.g., the weight or volume of the material, for example. The storage 140 stores a computer program to be executed by the computer 50, data to be referred to by the computer 50, and data generated by the computer 50. The controller 150 is configured or programmed to control travel and task operations of the agricultural machine 100. The controller 150 may be implemented as a device including a processor, e.g., an ECU. The communicator 190 transmits a signal generated by the computer 50 to the transport vehicle 300 and the terminal 400,

The transport vehicle 300 includes a positioning device 310, sensors 320, a localization device 330, a storage 340, the controller 350, and a communicator 390. The positioning device 310 includes a GNSS receiver. The sensors 320 include a plurality of sensors, such as a camera(s), a LiDAR sensor, and an ultrasonic sensor, for example. The sensors 320 are used for localization obstacle detection. The localization device 330 is a device to estimate the position of the transport vehicle 300 itself based on sensor data acquired by the sensors 320 and an environment map that is stored in the storage 340. The localization device 330 may include one or more processors and one or more memories. The storage 340 stores a computer program to be executed by the controller 350, data to be referred to by the controller 350, and data generated by the controller 350. The communicator 390 receives a signal transmitted from the agricultural machine 100.

The terminal 400 is a device to be used by a worker who performs loading work of the material for the transport vehicle 300 at a storage location of the material. The terminal 400 may be any computer such as a smartphone, a tablet computer, a desktop computer, or a laptop, for example. The terminal 400 includes a storage 440, a processor 450, a display 460, and a communicator 480. The storage 440 stores a computer program to be executed by the processor 450, data to be referred to by the processor 450, and data generated by the processor 450. The communicator 390 receives a signal transmitted from the agricultural machine 100. In the example of FIG. 8, with the aforementioned method,

the computer 50 in the agricultural machine 100 determines the transport start of the timing transport vehicle 300 and the loading start timing of the material. In other words, the computer 50 determines the transport start timing based on the consumption status of the material as determined or estimated based on a signal that is output from the positioning device 110 or the remaining amount sensor 120, and positional information of the storage location and the delivery location recorded in the storage 140. Furthermore, the computer 50 determines the loading start timing based on the transport start timing and the transport amount of the material to be transported by the transport vehicle 300. The transport amount of the material to be transported by the transport vehicle 300 is previously set, and recorded in the storage 140. The computer 50 is configured or programmed to transmit information of the transport start timing to the transport vehicle 300 via the communicator 190. Moreover, the computer 50 is configured or programmed to transmit a notification including information of the loading start timing and the transport start timing to the terminal 400, via the communicator 190. When the communicator 480 receives the notification from the agricultural machine 100, the processor 450 of the terminal 400 causes the display 460 to display the loading start timing and the transport start timing. Based on the displayed information, the worker performs loading of the material onto the transport vehicle 300, between the loading start timing and the transport start timing. After loading of the material is completed, the worker may operate the terminal 400 or control equipment of the transport vehicle 300 to give a notification to the controller 350 of the transport vehicle 300 that loading has been completed. The controller 350 of the transport vehicle 300 is configured or programmed to begin self-traveling toward the delivery location at the transport start timing as determined by the computer 50. Thus, the controller 350 may begin self-traveling toward the delivery location upon receiving a notification that loading of the agricultural material onto the transport vehicle 300 has been completed at the storage location and upon acquiring information indicating the transport start timing. This can prevent the transport vehicle 300 from beginning transport before loading of the material is completed. If loading of the material onto the transport vehicle 300 is not completed at the transport start timing, the controller 350 of the transport vehicle 300 may transmit an alert to the terminal 400 or the agricultural machine 100. This makes it possible to call the attention of the user of the terminal 400 or the worker for the agricultural machine 100 that loading work is behind.

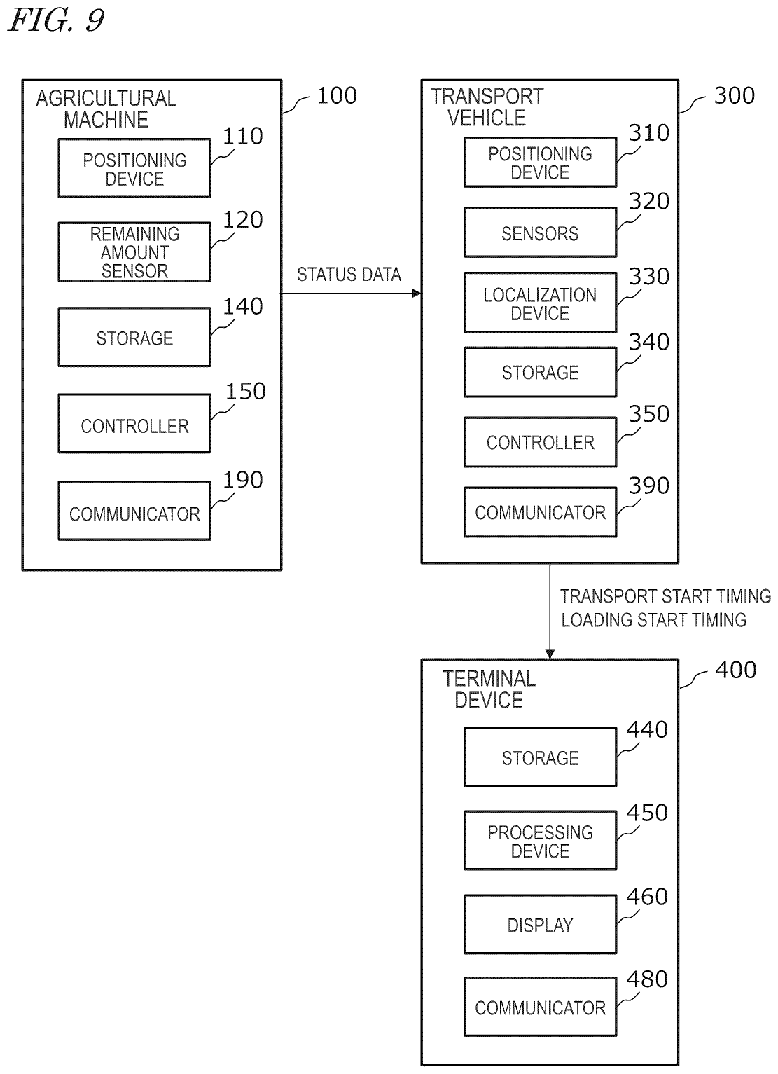

FIG. 9 is a block diagram showing another example configuration for the material provision system. In the example shown in FIG. 9, the computer 50 is mounted not in the agricultural machine 100 but in or on the transport vehicle 300. Otherwise, the configuration shown in FIG. 9 is identical to the configuration shown in FIG. 8.

In the example of FIG. 9, with the aforementioned method, the computer 50 in the transport vehicle 300 determines the transport start of the timing transport vehicle 300 and the loading start timing of the material. In other words, the computer 50 determines the transport start timing based on the consumption status of the material as estimated based on status data including a signal that is output from the positioning device 110 or the remaining amount sensor 120 of the agricultural machine 100, and positional information of the storage location and the delivery location recorded in the storage 340. Furthermore, the computer 50 determines the loading start timing based on the transport start timing and the transport amount of the material to be transported by the transport vehicle 300, The transport amount of the material to be transported by the transport vehicle 300 is previously set, and recorded in the storage 340. The computer 50 transmits a notification including information of the loading start timing and the transport start timing to the terminal 400, via the communicator 390. Based on the displayed information, the worker using the terminal 400 begins loading of the material onto the transport vehicle 300. After loading of the material is completed, the controller 350 of the transport vehicle 300 is configured or programmed to begin self-traveling toward the delivery location at the transport start timing as determined by the computer 50.

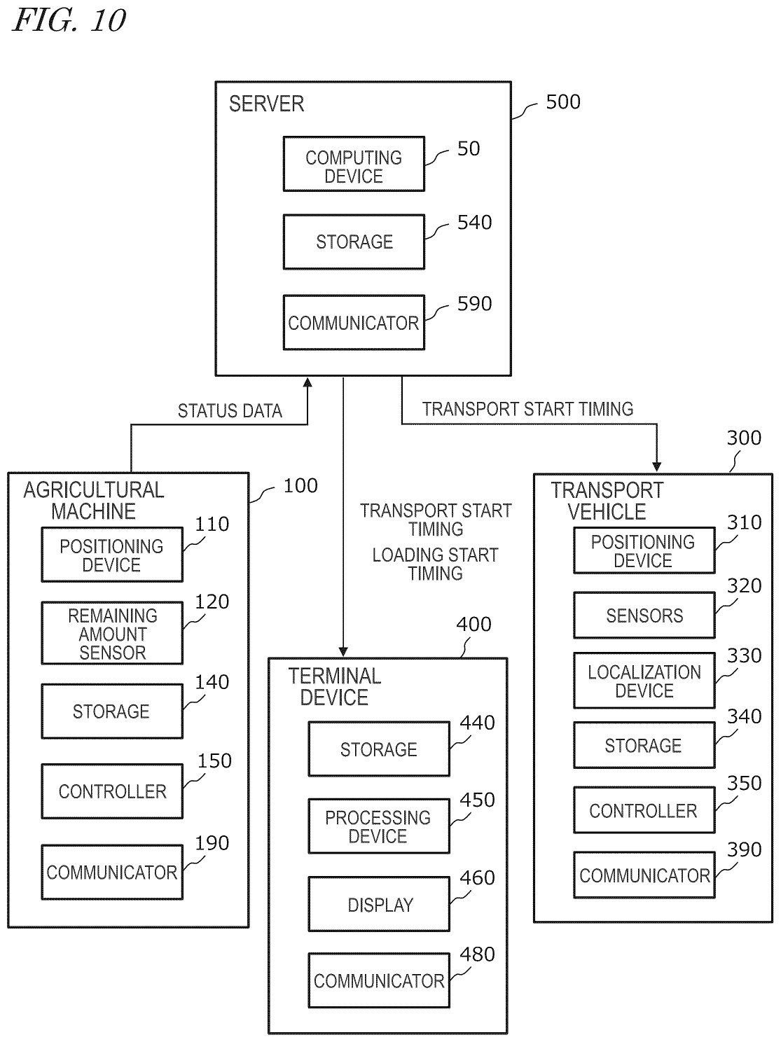

FIG. 10 is a block diagram showing still another example configuration for the material provision system. In addition to the agricultural machine 100, the transport vehicle 300, and the terminal 400, the material supply system shown in FIG. 10 includes a server 500. In this example, the computer 50 is mounted in or on the server 500.

The server 500 is a computer that is provided in a remote place (e.g., a data center) from the agricultural machine 100, the transport vehicle 300, and the terminal 400. The server 500 Communicates with the agricultural machine 100, the transport vehicle 300, and the terminal 400 via telecommunication lines including the Internet, for example. The server 500 includes the computer 50, a storage 540, and a communicator 590. The storage 540 stores a computer program to be executed by the computer 50, data to be referred to by the computer 50, and data generated by the computer 50. The communicator 590 performs exchange of signals between itself and each of the agricultural machine 100, the transport vehicle 300, and the terminal 400.

In the example of FIG. 10, with the aforementioned method, the computer 50 in the server 500 determines the transport start of the timing transport vehicle 300 and the loading start timing of the material. In other words, the computer 50 is configured or programmed to determine the transport start timing based on the consumption status of the material as estimated based on status data including a signal that is output from the positioning device 110 or the remaining amount sensor 120 of the agricultural machine 100, and positional information of the storage location and the delivery location recorded in the storage 540. Furthermore, the computer 50 is configured or programmed to determine the loading start timing based on the transport start timing and the transport amount of the material to be transported by the transport vehicle 300, The transport amount of the material to be transported by the transport vehicle 300 is previously set, and recorded in the storage 540. The computer 50 is configured or programmed to transmit information indicating the transport start timing to the transport vehicle 300, via the communicator 590. The computer 50 is configured or programmed to transmit a notification including information of the loading start timing and the transport start timing to the terminal 400, via the communicator 590. Based on the displayed information, the worker using the terminal 400 begins loading of the material onto the transport vehicle 300. After loading of the material is completed, the controller 350 of the transport vehicle 300 begins self-traveling toward the delivery location at the transport start timing determined by the computer 50.

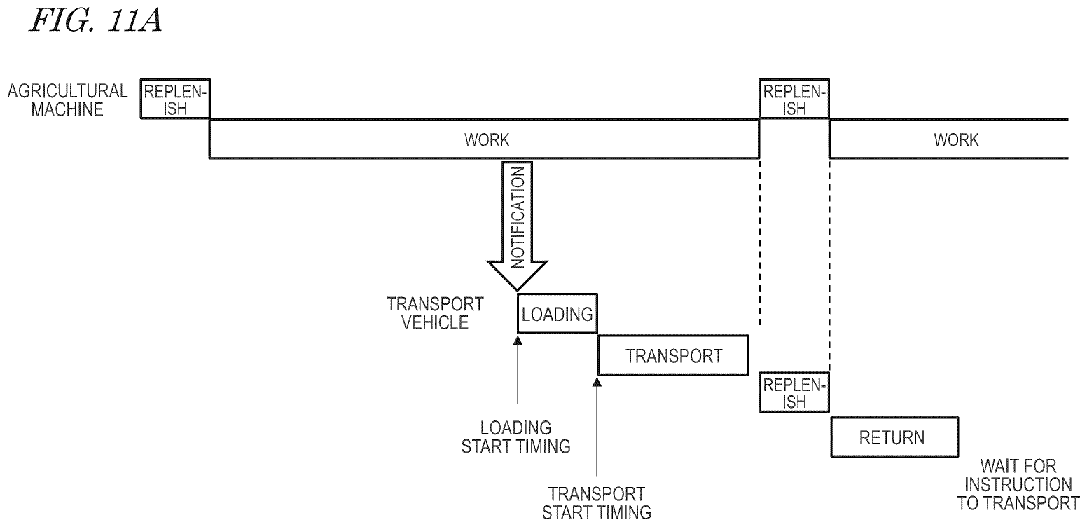

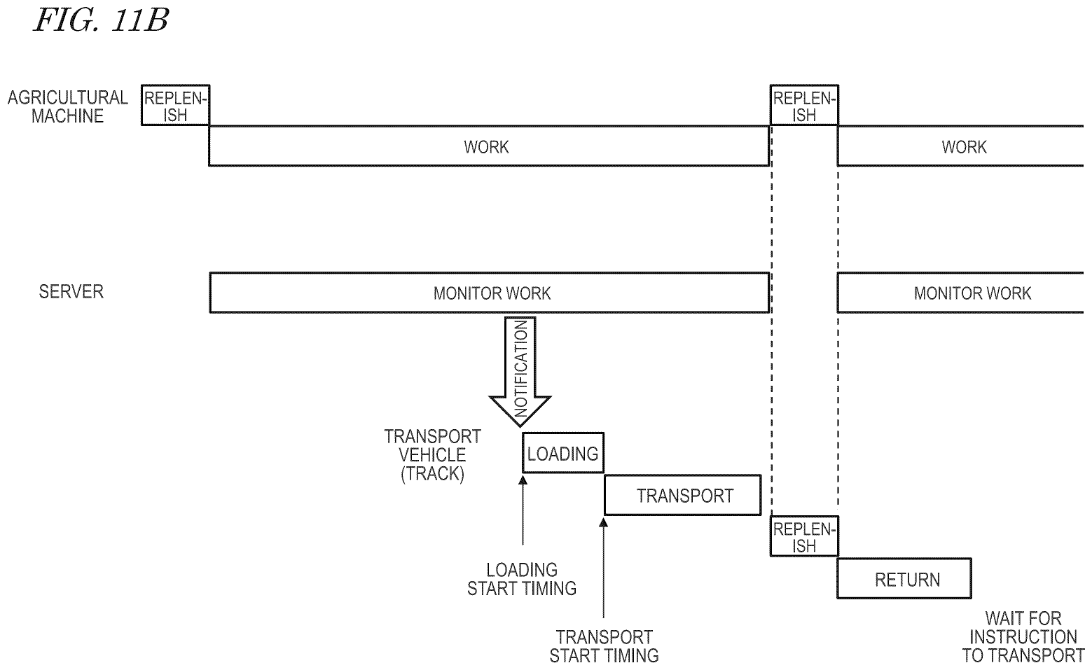

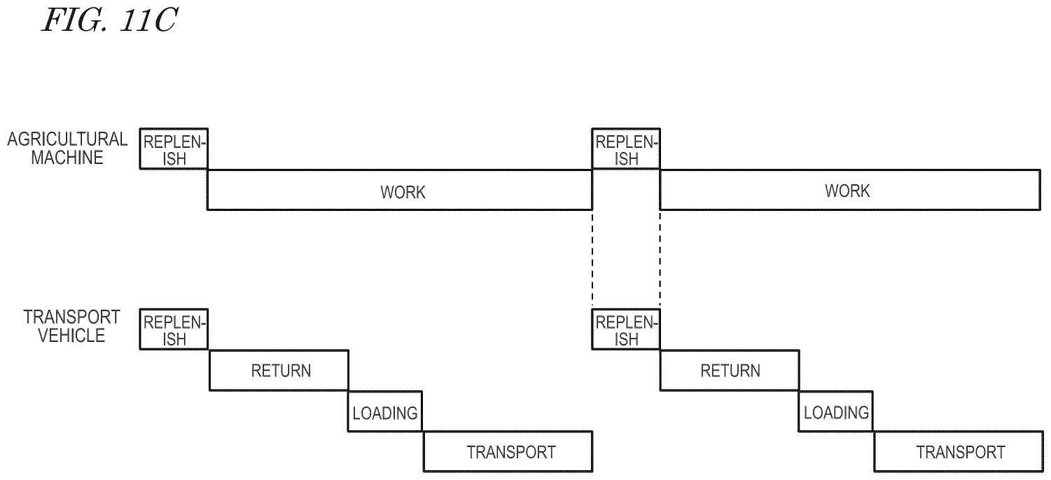

Next, with reference to FIG. 11A to FIG. 11C, an example of an overall operation of the material supply system will be described.

FIG. 11A is a diagram showing an example of an overall operation of the material supply system. In the example shown in FIG. 11A, the material supply system has the configuration shown in FIG. 8. The computer 50 is mounted in or on the agricultural machine 100, Once replenishing the material (e.g., seedlings) before the start of work, the agricultural machine 100 (e.g., a rice transplanter) begins tasked travel. During work, from a previously-set work path, the traveling speed of the agricultural machine 100 during work, and the initially-carried amount of the material, the computer 50 of the agricultural machine 100 can predict a point of time (time of depletion) and a geographical point (point of depletion) at which the material will become depleted. In particular, in a case where the traveling speed during work is previously determined, it is possible to estimate the time of depletion and the point of depletion before the agricultural machine 100 begins work. Based on the time of depletion, the estimated traveling time of the transport vehicle 300, and the amount of material to be transported, the computer 50 is configured or programmed to determine a transport start timing and a loading start timing. The computer 50 is configured or programmed to give a notification of the loading start timing and the transport start timing to the terminal 400 that is used by a worker to perform loading work of the material at the storage location, and gives a notification of the transport start timing to the transport vehicle 300. The worker performs loading work of the material onto the transport vehicle 300, between the loading start timing and the transport start timing. After loading of the material is completed, the transport vehicle 300 begins transporting the material to the delivery location at the transport start timing.

Based on the estimated time of depletion of the material and the estimated traveling time of the transport vehicle 300, the transport start timing is set to an appropriate point of time. Therefore, the transport vehicle 300 is able to arrive at the delivery location before the material carried on the agricultural machine 100 becomes depleted. If the material becomes depleted, the agricultural machine 100 stops work, and heads for the delivery location. At the delivery location, the material is taken down from the transport vehicle 300, and the agricultural machine 100 is replenished with the material. The material replenishment operation may be performed by a driver of the agricultural machine 100 or an assistant, for example. When a person rides on the transport vehicle 300, that person may perform the material replenishment operation. The material taken down from the transport vehicle 300 may be temporarily placed on a road or a furrow around the field. When the material replenishment is completed, the worker operates a smartphone or other devices to give a returning command to the transport vehicle 300. Upon receiving the returning command, the transport vehicle 300 automatically returns to the storage location. On the other hand, the agricultural machine 100 goes back to the geographical point at which the work in the field was stopped, and restarts work. Once going back to the storage location, the transport vehicle 300 stands by until a notification is again received from the agricultural machine 100. Upon again receiving a notification from the agricultural machine 100, the transport vehicle 300 again performs the aforementioned operation. The foregoing operation is repeated.

The position of the delivery location may be changed as the work by the agricultural machine 100 progresses. The agricultural machine 100 moves over time, and in some cases may move between fields to perform work in another field. Accordingly, the computer 50 may determine as the delivery location a place that will be near an estimated position (point of depletion) of the agricultural machine 100 at the time when the material becomes depleted. In that case, the agricultural machine 100 may send to the transport vehicle 300 a notification including positional information of the delivery location. Based on the notified positional information of the delivery location and an environment map stored in the storage 340, the controller 350 of the transport vehicle 300 may set a path to the delivery location and perform self-traveling.

FIG. 11B is a diagram showing an example of an overall operation of another example of the material supply system. In the example shown in FIG. 11B, the material supply system has the Configuration shown in FIG. 10. The computer 50 is mounted in or on the server 500. In advance, information of an amount of material carried on the transport vehicle 300, a transport time of the material, and a work path of the agricultural machine 100 is input to the server 500, and such information is stored in the storage 540. During work of the agricultural machine 100, the server 500 consecutively acquires information such as the position of the agricultural machine 100, and monitors whether the work by the agricultural machine 100 is progressing as planned. Based on the information consecutively acquired from the agricultural machine 100, the computer 50 of the server 500 determines transport start timing and a loading start timing. The computer 50 is configured or programmed to provide a notification of the loading start timing and the transport start timing to the terminal 400 that is used by a worker to perform loading work of the material at the storage location, and provide a notification of the transport start timing to the transport vehicle 300. The worker performs loading work of the material onto the transport vehicle 300, between the loading start timing and the transport start timing. After loading of the material is completed, the transport vehicle 300 begins transporting the material to the delivery location at the transport start timing. The subsequent operation is identical to the operation in the example shown in FIG. 11A.

FIG. 11C is a diagram showing an example of an overall operation in still another example of the material supply system. In the example shown in FIG. 11C, the material supply system has the configuration shown in FIG. 10. The computer 50 is mounted in or on the transport vehicle 300. The transport vehicle 300 in this example is configured to circulate through a predetermined route via self-traveling. The computer 50 of the transport vehicle 300 is configured or programmed to consecutively acquire information of the position of the agricultural machine 100 and the like, and based on that information, estimate a geographical point and a point in time at which the material will become depleted next. The computer 50 is configured or programmed to set a delivery location near the estimated geographical point, and determine a transport start timing so that the delivery location will be arrived at before the time of depletion. In this example, the transport vehicle 300 begins transporting the material at the transport start timing that has been determined by itself, and once replenishment is completed and a returning command is received, the transport vehicle 300 automatically returns to the storage location. Once returning to the storage location, material is loaded onto the transport vehicle 300 for next replenishment. In this state, the transport vehicle 300 determines a next transport start timing and a next delivery location based on the state of the agricultural machine 100. Thereafter, a similar operation is repeated.

In the example of FIG. 11C, the computer 50 is mounted in or on the transport vehicle 300. However, the computer 50 may be mounted in or on the agricultural machine 100 or the server 500. In that case, the computer 50 may determine the transport start timing and the position of the delivery location, and, at the transport start timing, transmit to the transport vehicle 300 a traveling command including positional information of the delivery location. In response to the traveling command, the transport vehicle 300 begins transporting the material to the designated delivery location.

In the examples from FIG. 11A to FIG. 11C, after completion of replenishment at the delivery location, the transport vehicle 300 goes back to the storage location. Alternatively, without going back to the storage location, it may halt, or head for another place. For example, after material replenishment is completed, the transport vehicle 300 may head for another delivery location in order to replenish the material for another agricultural machine. Moreover, it may not necessarily be while the transport vehicle 300 is standing by at the storage location that the transport vehicle 300 receives a command to start transportation. Even while the transport vehicle 300 is traveling, a command requesting that the material be transported at a specific point of time to a specific delivery location may be issued from the agricultural machine 100 or the server 500. Moreover, during travel, the transport vehicle 300 may determine a timing and a delivery location for a next replenishment based on status data that is transmitted from the agricultural machine 100, and control its own travel so as to reach the determined delivery location in a timely manner.

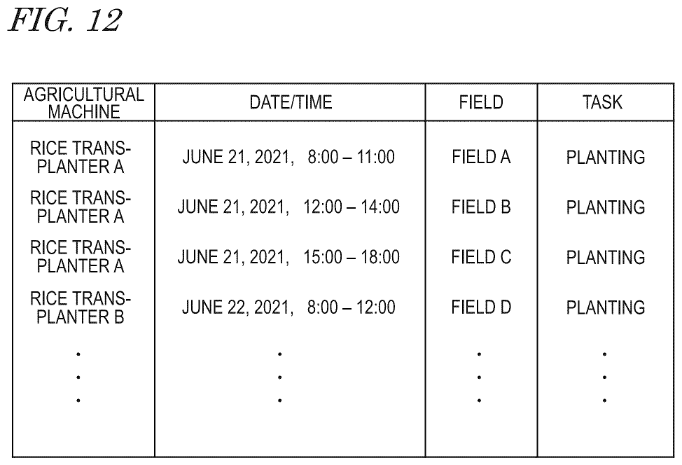

In the above example embodiments, the agricultural machine 100 may travel via manual driving, or travel via self-driving. In the case where the agricultural machine 100 travels via self-driving, the agricultural machine 100 may travel in accordance with a previously-set work plan. As shown in FIG. 12, for example, the work plan may include information identifying the agricultural machine, work day, start time of work, end time of work, field, content of work, and the like. The work plan may include information of the work path and the work speed (i.e., traveling speed during work) of the agricultural machine 100. In that case, the computer 50 can estimate the consumption status of the material based on the previously-set work plan for the agricultural machine 100. For example, based on the information of the work path and work speed of the agricultural machine 100 included in the work plan, the computer 50 can estimate the consumption status of the material at each geographical point within the field. Based on the consumption status of the material thus estimated, the computer 50 may determine the transport start timing and the loading start timing.

Hereinafter, a specific example of the configuration of the agricultural machine 100 in a case where the agricultural machine 100 is a rice transplanter that is capable of self-traveling will be described.

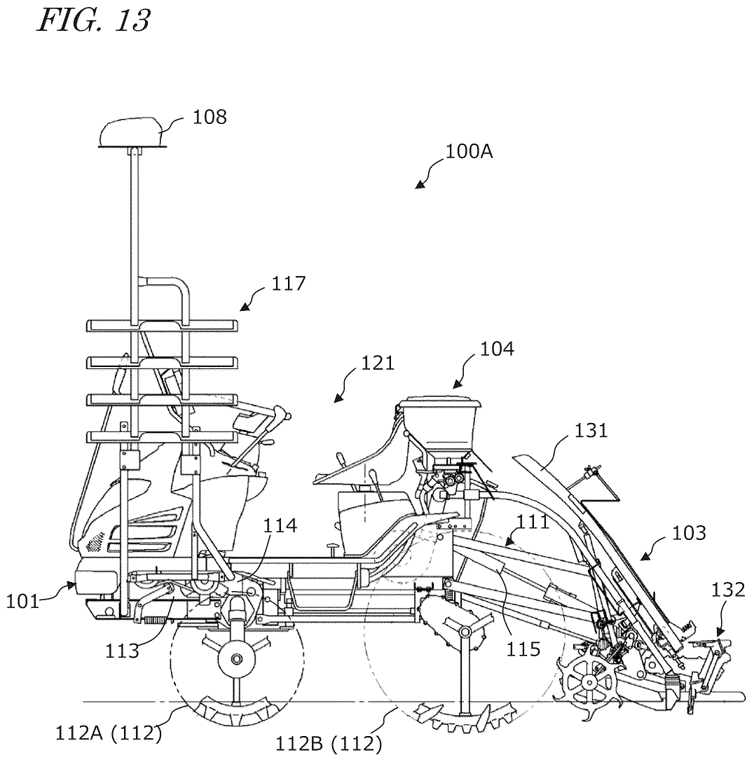

FIG. 13 is a side view showing an example configuration of a rice transplanter 100A as an example of the agricultural machine 100. The rice transplanter includes a machine body 101 that is of a riding type and four-wheel drive. The machine body 101 includes a link mechanism 111, a lifting cylinder 115, a seedling planting device 103, and a manure spreading device 104.

As a mechanism for traveling, the machine body 101 includes wheels 112, an engine 113, and a hydraulic continuously variable transmission 114. The wheels 112 include steerable right and left front wheels 112A, and right and left rear wheels 112B. The engine 113 and the continuously variable transmission 114 are mounted at the front of the machine body 101. Motive power from the engine 113 is supplied to the front wheels 112A, the rear wheels 112B, the seedling planting device 103, and the manure spreading device 104 via the continuously variable transmission 114 and the like. The seedling planting device 103 includes a seedling platform 131 and a planting mechanism 132.

The machine body 101 includes a driving section 121. The driving section 121 includes a steering wheel, a main gear shift lever, a range gear shift lever, a task operation lever, a driver's seat, and the like. Furthermore, reserve seedling frames 117 to accommodate reserve seedlings are provided frontward of the driving section 121. A positioning device 108 is provided above the reserve seedling frames 117.

The positioning device 108 outputs positioning data to calculate the position and direction of the machine body 101. The positioning device 108 includes a satellite positioning module to receive radio waves from GNSS satellites, and an inertial measurement module to detect the tilt and acceleration of the machine body 101 in three axes.

Other than the component elements shown in FIG. 13, the rice transplanter 100A also includes a controller 150 (see FIG. 9) configured or programmed to control self-traveling and various sensors. The sensors may include sensors to detect states such as the steering angle, the operating positions of a main gear shift lever and a range gear shift lever, the vehicle speed, and the engine revolutions, and setting values therefor, for example. The sensors may also include sensors to detect states of the link mechanism 111, the seedling planting device 103, and the manure spreading device 104 and setting values therefor. For example, the sensors may include the remaining amount sensor 120 (see FIG. 9) to measure the remaining amount of an agricultural material, such as a remaining amount of seedlings or a remaining amount of fertilizer.

By controlling the steering angle of the front wheels 112A and the continuously variable transmission 114, the controller 150 changes the vehicle speed and traveling direction of the rice transplanter 100A. Also, the controller 150 is configured or programmed to control the amount of seedling to be taken by the seedling planting device 103 and the amount of manure to be spread by the manure spreading device 104. Based on satellite positioning data that is consecutively sent from the positioning device 110, the controller 150 is configured or programmed to calculate coordinates (ego-position) of the rice transplanter 100A on the map. Based on the calculated ego-position and a previously-set target path, the controller 150 is configured or programmed to cause the rice transplanter 100A to travel along the target path.

The rice transplanter 100A is able to switch between a manual travel mode and a self-traveling mode. In the self-traveling mode, based on a lateral deviation and a directional deviation that are calculated through comparison between the ego-position and the target path, the controller 150 is configured or programmed to determine an amount of steering control so that the lateral deviation and directional deviation are reduced. Based on the determined amount of steering control, the steering angle of the front wheels 112A is adjusted. Moreover, the controller 150 is configured or programmed to control the traveling speed so that travel is performed at a speed that is equal to or below a previously-set reference speed. In the manual travel mode, based on a manipulated variable of the steering wheel, the controller 150 is configured or programmed to adjust the steering angle of the front wheels 112A. The controller 150 is configured or programmed to control the continuously variable transmission 114 so that travel is performed at a traveling speed that is in accordance with the operating positions of the main gear shift lever and the range gear shift lever.

The techniques and example embodiments according to the present disclosure are applicable to material supply systems for agricultural machines that perform agricultural work while consuming an agricultural material, e.g., rice transplanters, vegetable transplanters, tractors, spreaders, seeders, and chemical sprayers, for example.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A material supply system that causes a transport vehicle to supply an agricultural material for consumption by an agricultural machine in agricultural work, the material supply system comprising:
a computer configured or programmed to determine a transport start timing for the transport vehicle toward a delivery location of the agricultural material, based on a consumption status of the agricultural material in an agricultural task by the agricultural machine in a field, a position of a storage location of the agricultural material, and a position of the delivery location.

2. The material supply system of claim 1, wherein the computer is configured or programmed to:
estimate a time of depletion at which a remaining amount of the agricultural material becomes smaller than a predetermined amount based on the consumption status of the agricultural material;
estimate a traveling time required by the transport vehicle in order to move to the delivery location based on a relative positioning of the storage location of the agricultural material and the delivery location of the agricultural material; and
determine the transport start timing based on the time of depletion and the traveling time.

3. The material supply system of claim 2, wherein the computer is configured or programmed to determine, as the transport start timing, a timing before a point in time that is derived by subtracting the traveling time from the time of depletion.

4. The material supply system of claim 1, wherein the computer is configured or programmed to transmit information indicating the transport start timing to a controller configured or programmed to control self-driving of the transport vehicle.

5. The material supply system of claim 1, wherein the computer is configured or programmed to determine a loading start timing at which to begin loading of the agricultural material onto the transport vehicle based on the transport start timing and a transport amount of the agricultural material to be transported by the transport vehicle.

6. The material supply system of claim 5, wherein the computer is configured or programmed to:
estimate a loading time required for loading the agricultural material onto the transport vehicle based on the transport amount; and
determine, as the loading start timing, a timing before a point in time that is derived by subtracting the loading time from the transport start timing.

7. The material supply system of claim 5, wherein the computer is configured or programmed to provide a notification of the loading start timing to a terminal usable by a worker to perform the loading work.

8. The material supply system of claim 1, further comprising a controller configured or programmed to acquire information indicating the transport start timing and to control self-driving of the transport vehicle; wherein
the controller is configured or programmed to, upon acquiring the information indicating the transport start timing, initiate self-traveling toward the delivery location at the transport start timing.

9. The material supply system of claim 1, 1 wherein the computer is configured or programmed to monitor a state of the agricultural machine, and estimate the consumption status of the agricultural material based on the state of the agricultural machine.

10. The material supply system of claim 9, wherein the computer is configured or programmed to monitor a position and a moving speed of the agricultural machine, and estimate the consumption status of the agricultural material based on the position and the moving speed of the agricultural machine.

11. The material supply system of claim 1, wherein the computer is configured or programmed to estimate the consumption status of the agricultural material based on a previously-set work plan of the agricultural machine.

12. The material supply system of claim 11, wherein the computer is configured or programmed to estimate the consumption status of the agricultural material based on information of a work path and a work speed of the agricultural machine included in the work plan.

13. The material supply system of claim 1, wherein the computer is configured or programmed to:
estimate a point of depletion at which the remaining amount of the agricultural material becomes smaller than a predetermined amount, based on the consumption status of the agricultural material, a work path of the agricultural machine, and a position and a moving speed of the agricultural machine; and
determine the delivery location in accordance with the point of depletion.

14. The material supply system of claim 8, wherein, based on a previously-set operating schedule of the transport vehicle, the controller is configured or programmed to control self-traveling of the transport vehicle to circulate through a route that includes the storage location and the delivery location.

15. The material supply system of claim 8, wherein, after unloading of the agricultural material from the transport vehicle is completed at the delivery location, the controller is configured or programmed to initiate self-traveling from the delivery location to the storage location, in response to a command from a device that is operated by a user.

16. The material supply system of claim 8, wherein the controller is configured or programmed to initiate self-traveling to the delivery location, upon receiving a notification that loading of the agricultural material onto the transport vehicle at the storage location has been completed and upon acquiring information indicating the transport start timing.

17. The material supply system of claim 1, wherein the computer is mounted in or on the agricultural machine, in a computer configured or programmed to communicate with the agricultural machine, or in or on the transport vehicle.

18. The material supply system of claim 1, wherein
the agricultural material includes seedlings of a plant; and
the agricultural machine is a transplanter that travels while planting seedlings of the plant in a field.

19. A method of causing a transport vehicle to supply an agricultural material for consumption by an agricultural machine in agricultural work, the method comprising:
acquiring information of a consumption status of the agricultural material in an agricultural task by the agricultural machine in a field, information of a position of a storage location of the agricultural material, and information of a position of a delivery location of the agricultural material;
based on the consumption status of the agricultural material, the position of the storage location, and the position of the delivery location, determining a transport start timing for the transport vehicle toward the delivery location; and
providing information indicating the transport start timing for a controller configured or programmed to control self-driving of the transport vehicle.
